(19) United States
(12) Patent Application Publication
(10) Pub. No.: US 2008/0153643 A1
(43) Pub. Date: Jun. 26, 2008

(54) Flexible Drive Comprising at Least One Guide for Tensioning and/or Guiding a Continuous Traction Mechanism

(75) Inventors: Gunther Franke, Oberreichenbach (DE); Gerhard Prosch, Hochstadt (DE); Bolko Schuseil, Adelsdorf (DE); Thomas Ullein, Frensdorf (DE); Reinhard Koch, Wachenroth (DE); Martin Assel, Burgbernheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schaeffler KG, Herzogenaurach (DE)

(21) Appl. No.: 11/911,910

(22) PCT Filed: Feb. 3, 2006
(86) PCT No.: PCT/EP06/00931

§ 371 Date: Oct. 18, 2007

(30) Foreign Application Priority Data
Apr. 22, 2005 (DE) 10 2005 018 901.6

(51) Int. Cl. F16H 7/18

(52) U.S. Cl. 474/111

(57) ABSTRACT

A traction mechanism that includes at least one guide (1, 1′-1′″″) for tensioning or guiding a continuous traction drive element, especially a chain of the control drive of an internal combustion engine is provided. The guide (1, 1′-1′″″) is made of plastic and metal inserts and has a double T cross-section having an upper member (3) and a lower member (4) that are connected by a central web (5) and ribs (6) arranged endwise on both ends of the web (5). The invention provides a rigid, compact and inexpensive guide. For this purpose, the guide (1, 1′-1″″″) includes two lateral plates (2, 2′-2′″″, 18, 19), preferably made from steel, that are inserted into recesses (7) in the side faces (29) of the ribs (6) in a play-free manner and are held in position by form fitting fastening elements.

### BACKGROUND

The invention relates to a traction mechanism with at least one guide for tensioning and/or guiding an endless traction drive element, especially for a chain of the control drive of an internal combustion engine.

In U.S. Pat. No. 6,796,917 B2, a traction mechanism drive is disclosed, which comprises at least one guide that is used for tensioning or guiding an endless traction drive element, especially a chain of the control drive of an internal combustion engine, wherein the guide, which is comprised of plastic and metallic inserts, has a double-T cross section with an upper member and a lower member that are connected by a central web and by ribs extending perpendicular on its two sides.

### SUMMARY

The invention is based on the objective of providing a traction mechanism drive according to the preamble of claim 1, whose guide is more rigid, more compact, and more cost-effective relative to the state of the art.

The object is met by the features of the independent claim 1.

The two side plates, which are made from metal—preferably steel—and which are set in fitting recesses of the ribs on both sides of the web preferably without play, increase the low modulus of elasticity and thus the stiffness and compactness of the guides. The form-fit fastening means secure the side plates against falling out in a simple and cost-effective way.

The side plates can also be set between the insides of the upper and lower member advantageously without play and can contact the entire side surface of the ribs.

As a simple fastening means, there are so-called snap-on hooks or snap-on hook wraps, which are formed in one piece with the guide and are produced with it in one processing step. The elasticity of the plastic allows simple shaping of the snap-on hooks, because these yield elastically when inserting the side plates into the recesses and spring back into a starting and locking position after the insertion.

It is also advantageous that an attachment and bearing element, e.g., a screw or a pin, which are provided for attaching and supporting the guide on the internal combustion engine, is used as additional fastening means for correspondingly shaped side plates provided with a matching borehole. This improves the attachment of the side plates without greater production and assembly expense.

In this way, a simplified production and assembly is achieved such that both side plates have as additional fastening means at least one bar, through which these elements are connected to each other that is located at any position, and the side plates are formed as a one-piece bent-up part.

An advantageous refinement of the invention is provided in that first and/or second undercut sections of a guide are used as fastening means, behind which a corresponding part of a first and/or second displaceable side plate can be shifted. Here, there are two alternatives:

The first undercut sections of the guide project into the contours of the first displaceable side plates. For mounting these side plates, recesses matching the side plate edge facing the first undercut sections are provided for the first undercut sections.

The second undercut sections of the guides are arranged outside of the contours of the second displaceable side plates. For the mounting, the side plate edge facing the second undercut sections have projections matching the second displaceable side plates and the required free space for their insertion into the second undercut sections.

An especially simple solution of the attachment of the side plates is provided in that these are extrusion coated at least partially with plastic in the production of the guide.

An especially stable attachment of the side plates is provided when the side plates are connected rigidly to each other and therefore also to the guide at the ends of a guide and in intermediate openings in this guide through, e.g., welds or rivets.

Another attachment possibility for the side plates consists in that these have at least one Z-shaped or U-shaped end and that the Z-shaped end engages with a form fit in an opening of a guide, and the U-shaped end surrounds a guide with a form fit in another opening of this guide.

### BRIEF DESCRIPTION OF THE DRAWINGS

Additional features of the invention emerge from the following description and the drawings, in which embodiments of the invention are shown schematically.

Shown are:

FIG. 1 a perspective exploded view of a guide with two side plates;

FIG. 1a a perspective view of the guide from FIG. 1, but with mounted side plates;

FIG. 1b a side view of the guide from FIG. 1a;

FIG. 1c a cross sectional view A-A through the guide from FIG. 1b;

FIG. 1d a cross-sectional view B-B through the guide from FIG. 1b;

FIG. 2 a perspective exploded view of a guide from FIG. 1 but with modified side plates;

FIG. 3 a perspective view of the guide from FIG. 1 and of two side plates connected by a bar;

FIG. 4 a side view of a detail of a guide with a displaceable side plate and a first undercut section;

FIG. 5 a side view of another detail of a guide with a displaceable side plate and a second undercut section;

FIG. 6 a side view of a detail of a guide with a partially plastic extrusion coated side plate;

FIG. 7 a guide with two side plates, which are connected rigidly to each other and to the guide at the ends and in openings of the guide;

FIG. 8 a guide with an opening, in which a Z-shaped end of a side plate engages with a form fit;

FIG. 8a a guide with another opening, in which a U-shaped end of a side plate engages and which surrounds the guide with a form fit.

### DETAILED DESCRIPTION OF THE PREFERRED EMBODIMENTS

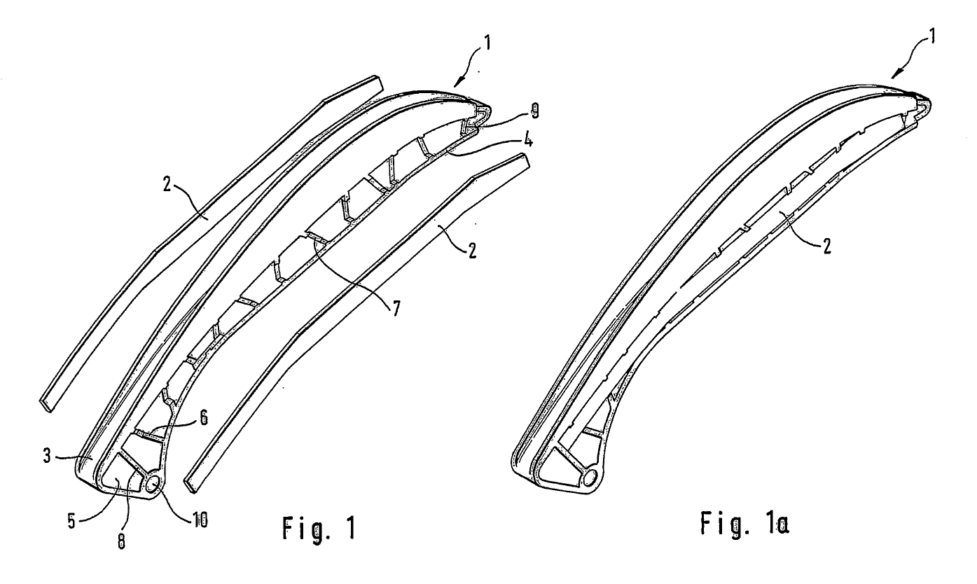

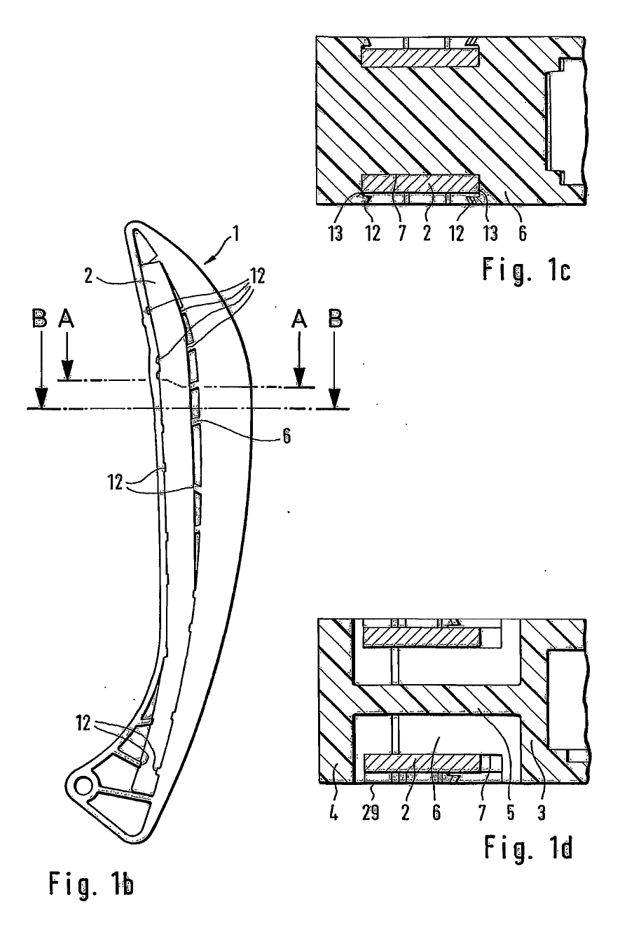

FIG. 1 shows a guide 1 according to the invention formed as a tensioning guide with two side plates 2 in a perspective exploded view. The guide 1, which is made from plastic, is used for tensioning and guiding an endless traction drive element, especially a chain of the control drive of an internal combustion engine. The side plates 2 are made from steel and are used for stiffening and reinforcing the guide 1.

The guide 1 (see also FIG. 1d) has a double-T cross section with an upper member 3 and a lower member 4, which are connected by a center web 5 and by ribs 6 extending perpendicular on both sides of the web 5.

Recesses 7, in which the side plates 2 are set, are located in side surfaces 29 of the ribs 6. A first rib 8, which has no recess 7, is used as a stop for the side plates 2, while the last rib 9 allows unimpaired heat expansion of the side plates 2 relative to the guide 1.

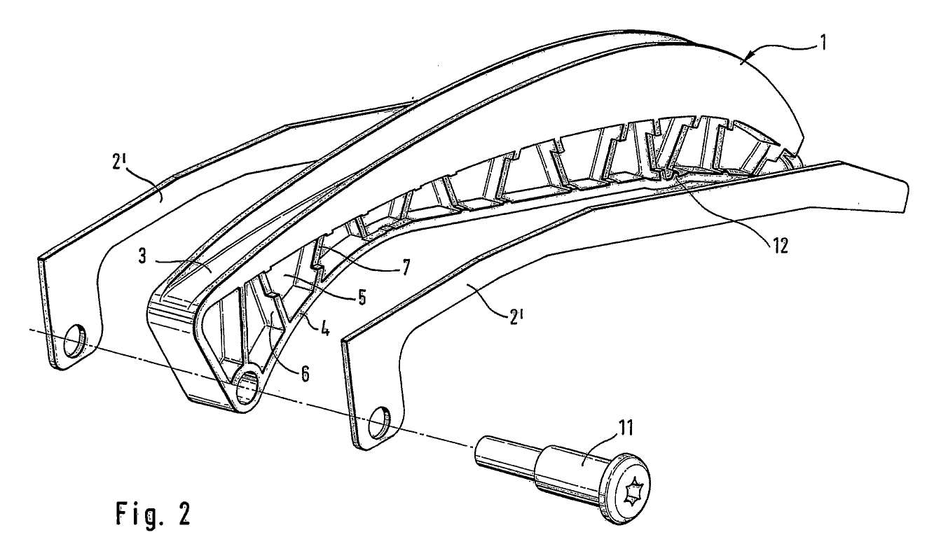

A borehole 10 is used for holding an attachment and bearing element 11, which can be formed as a screw or pin. (See also FIG. 2). It is used simultaneously for attaching the guide 1 to the internal combustion engine and as its pivot bearing.

In FIG. 1a, the guide 1 is shown in perspective view with the side plates 2 set on the side.

In FIG. 1b, a side view of the guide 1 with mounted side plates 2 is shown. In addition, the position of a few so-called snap-on hooks 12, which are used for attaching the side plates 2 into the recesses 7 (see also FIG. 1) of the ribs 6, is shown. This figure also includes the designation of the position of the cross sections A-A and B-B.

FIG. 1c shows the enlarged cross section A-A of the guide 1 from FIG. 1b, which extends through a rib 6 with snap-on hooks 12. Due to the symmetric arrangement of the side plates 2, the labeling is provided on only one side. The side plates 2 are located in the recesses 7 of the ribs 6 arranged on both sides of the web 5 (see FIG. 1d). These side plates preferably have no lateral play, in order to achieve optimum stiffening of the plastic guide through the steel side plates 2. The side plates 2 are prevented from falling out of their recesses 7 by the snap-on hooks 12. These are formed integrally with the guide and project past an edge 13 of the recesses 7 of the ribs 6. When placing the side plates 2 into the recesses 7, the snap-on hooks 12 yield elastically, and then spring back into a starting and locked position after the side plates are positioned and thus prevent the side plates from falling out.

In FIG. 1d, the cross section B-B from FIG. 1b is shown, which extends through a rib-free region of the guide 1. Also for this section, only one side is labeled due to its symmetry. The double-T cross section with the upper member 3, the lower member 4, and the web 5 connecting these members can be recognized clearly. This also applies to a rib 6 with its side surface 29 and its recess 7 with the side plate 2.

In FIG. 2, a perspective exploded view of the guide 1 according to FIG. 1 is shown, with upper member 3, lower member 4, web 5, ribs 6, recess 7 with modified side plates 2′. These are fixed laterally, in addition to the snap-on hooks 12, also by an attachment and bearing element 11, which is also used for attaching and supporting the guide 1 on the internal combustion engine.

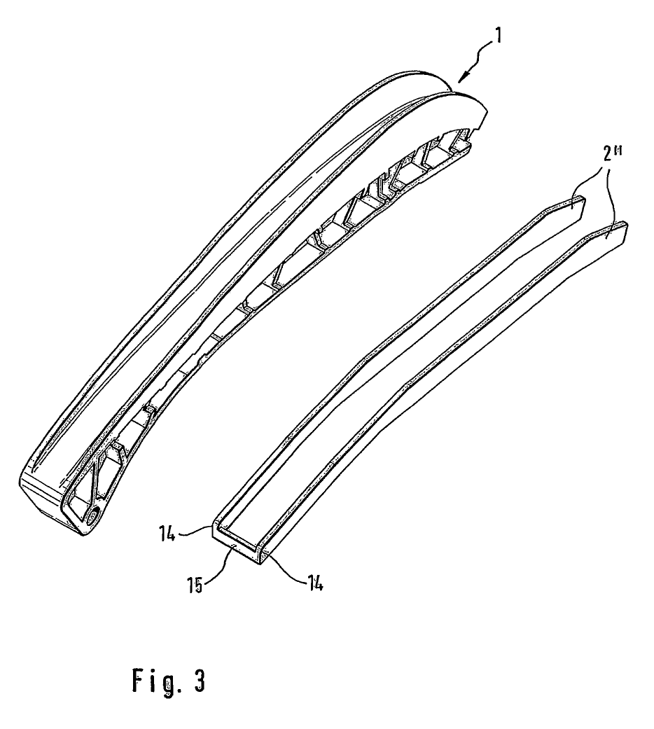

FIG. 3 shows a guide 1 according to FIGS. 1 and 2 but with side plates 2″, which are connected by a bar 15 at the ends 14 close to the screw and which are constructed as a one-piece bent-up part. This solution is distinguished by economical production and assembly. The two side plates 2″ can be connected at any position and with a selectable number of bars 15.

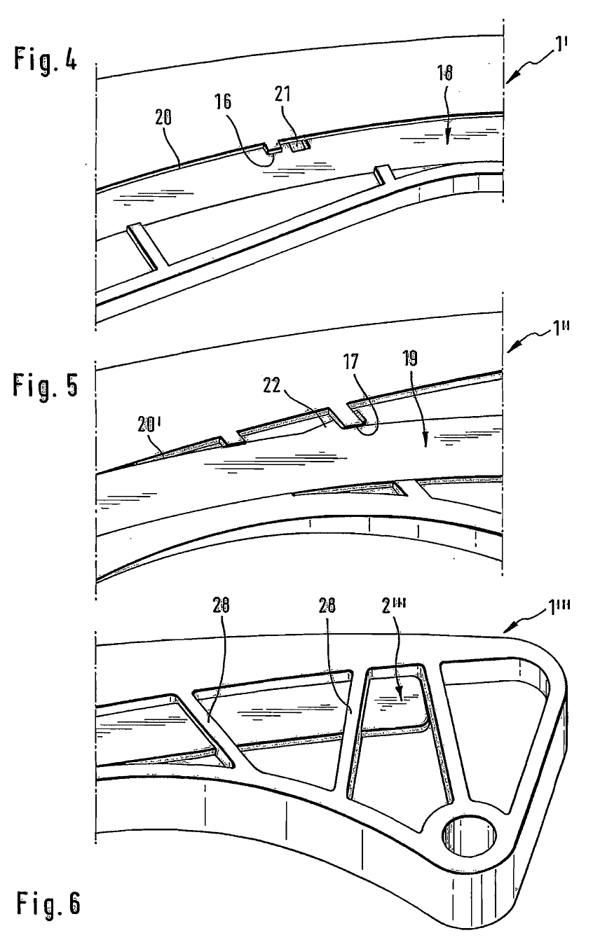

In FIGS. 4 and 5, details of guides 1′, 1″ are shown, which have first and/or second undercut sections 16 and/or 17. These are used as fastening means, behind which a matching part of a first and/or second displaceable side plate 18 and/or 19 can be inserted and generates its locking.

The first undercut sections 16 of the guide 1′ project into the contours of the first displaceable side plates 18 as shown in FIG. 4. For mounting the side plates 18, matching recesses 21 are provided on their side plate edge 20 facing the first undercut sections 16 for the first undercut sections 16.

The second undercut sections 17 of the guide 1″ shown in FIG. 5 are located outside of the contours of the second displaceable side plates 19. For their mounting, the side plate edge 20′ of the second displaceable side plates 19 facing the second undercut sections 17 have matching projections 22 and the necessary free space for their insertion into the second undercut sections 17.

FIG. 6 shows a detail of a guide 1′″ with a side plate 2′″. This is extrusion coated in the production of the guide 1′″ with plastic crossbars 28, which are used as especially economical fastening means for the side plates 2′″.

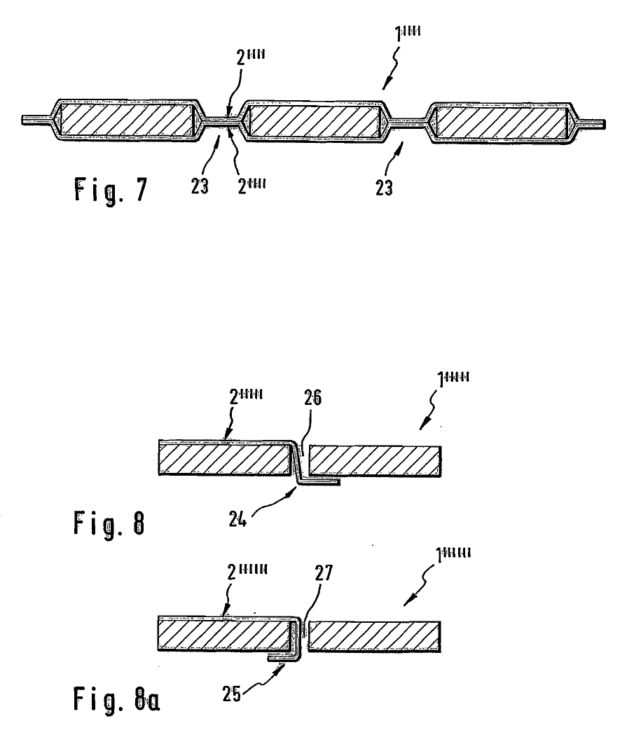

In FIG. 7, a guide 1″″ with two side plates 2″″ is shown schematically. The side plates 2″″ are connected to each other at the ends of the guide 1″″ and in intermediate openings 23 of this guide by welds or rivets. The connection is designed so that the side plates 2″″ are also connected rigidly to the guides 1″″ arranged between the side plates.

The guide 1′″″ of FIG. 8 shown schematically has an opening 26, in which a Z-shaped end 24 of a side plate 2′″″ engages with a positive fit. In a comparable way, FIG. 8a shows a schematic guide 1″″″ with an opening 27, in which a U-shaped end 25 of a side plate 2″″″ surrounds the guide 1″″″ with a positive fit.

The guides according to the invention are stiff, compact, and economical due to the reinforcement by the side plates.

The different fastening means for the side plates can be combined according to the application.

### REFERENCE SYMBOLS

1, 1′ to 1″″″ Guide
2, 2′ to 2″″″ Side plate
3 Upper member
4 Lower member
5 Web
6 Rib
7 Recess
8 First rib
9 Last rib
10 Borehole
11 Attachment and bearing element
12 Snap-on hooks
13 Edge
14 End close to screw
15 Bar
16 First undercut section
17 Second undercut section
18 First displaceable side plate
19 Second displaceable side plate
20, 20′ Side plate edge
21 Recess
22 Projection
23 Opening
24 Z-shaped end
25 U-shaped end
26 Opening
27 Opening
28 Plastic crossbar
29 Side surface

1. Traction mechanism drive comprising at least one guide for tensioning or guiding an endless traction drive element of an internal combustion engine, the guide is made from plastic and metal inserts, and includes a double-T cross section with an upper member and a lower member, which are connected by a central web and by ribs that project perpendicular on both sides of the web, the guide has two side plates made from steel, which are preferably set without play into matching recesses in side surfaces of the ribs and are fixed in position by positive-fit fastening elements.

2. Traction mechanism drive according to claim 1, wherein snap-on hooks, which are formed in one piece with the guide and which are arranged on edges of the recesses for at least a few of the ribs, are provided as the fastening elements, the snap-on hooks yield elastically when the side plates are set and spring back into a starting or fixed position after the side plates reach a mounted position.

3. Traction mechanism drive according to claim 1, wherein an attachment and bearing element are provided for attaching and supporting the guide on the internal combustion engine as additional fastening elements for correspondingly shaped side plates provided with a matching borehole.

4. Traction mechanism drive according to claim 1, wherein both of the side plates have at least one bar as additional fastening elements through which the side plates are connected to each other as a one-piece bent-up part.

5. Traction mechanism drive according to claim 1, wherein first and/or second undercut sections of the guide, behind which a corresponding part of the first and/or second displaceable side plate can be pushed in, are used as the fastening elements.

6. Traction mechanism drive according to claim 5, wherein the first undercut sections of the guide project into contours of the first displaceable side plates and for mounting the side plates, on a side plate edge facing the first undercut sections, matching recesses for mounting the first undercut sections are provided.

7. Traction mechanism drive according to claim 5, wherein the second undercut sections of the guide are arranged outside of the contours of the second, displaceable side plates and for their mounting, a side plate edge facing the second undercut sections has matching projections and a necessary free space for insertion of the side plates into the second undercut sections.

8. Traction mechanism drive according to claim 1, wherein the side plates are extrusion coated at least partially with plastic during production of the guide as the fastening elements for the side plates.

9. Traction mechanism drive according to claim 1, wherein the side plates are connected rigidly to each other and therefore also to the guide as the fastening elements to ends of the guide and/or in intermediate openings of the guide by welds or rivets.

10. Traction mechanism drive according to claim 1, wherein side plates have at least a Z-shaped or a U-shaped end as the fastening elements and the Z-shaped end engages with a positive fit in an opening of the guide and the U-shaped end surrounds the guide in an opening of the guide with a positive fit.

11. Traction mechanism drive according to claim 1, wherein the endless traction drive element comprises a chain of a control drive of the internal combustion engine.
